(19) United States
(12) Patent Application Publication
(10) Pub. No.: US 2007/0299789 A1
(43) Pub. Date: Dec. 27, 2007

(54) Assessing and Monetizing Bandwidth Usage in a Networked Mobile Application

(75) Inventor: Mark Young, San Jose, CA (US)

Correspondence Address: HAYNES BEFFEL & WOLFELD LLP, P O BOX 366, HALF MOON BAY, CA, 94019, US

(73) Assignee: Numobiq Inc., Pleasanton, CA (US)

(21) Appl. No.: 11/426,812

(22) Filed: Jun. 27, 2006

(51) Int. Cl. G06Q 40/00; G06F 17/00

(52) U.S. Cl. 705/400; 705/35

(57) ABSTRACT

A method of monetizing a software application for mobile devices. The initial step is developing a software application designed to operate on a mobile device, which is followed by determining a transaction unit for the application. The program proceeds by estimating the bandwidth usage of the application, determining a pricing model for the application and deploying the application, based on the pricing model. Finally, the program performs the step of monitoring consumer usage of the application and adjusting the pricing model as required.

### BACKGROUND OF THE INVENTION

The invention relates generally to the area of mobile service providers assessing and billing for the bandwidth usage by mobile device applications on their networks, and in particular to the system and methods for quantifying prior to deployment the estimated bandwidth usage by an application, establishing a value for that usage, and innovations around how that value is then reflected as a cost to a party other than the consumer in the mobile service provider's revenue distribution model.

Mobile service providers today have a fairly rudimentary means of monetizing the bandwidth provided by their networks. Typically, bandwidth is first segmented by access type, such as voice, SMS/MMS, Internet data, etc. The bandwidth usage by each type of access is then monetized by billing the consumer as defined by their service agreement. Agreements typically contain a certain number of voice minutes, SMS/MMS messages, and with data plans, a number of Kilobytes of data transfer.

Providers are hoping to grow revenues by increasing the consumer consumption of Internet data services. However, their approach to monetizing these services presents several drawbacks to both the providers themselves as well as the consumer.

For example, the predominant means of competition between mobile service providers is through their pricing plans. This means providers tend to reduce their service pricing over time in order to compete effectively. The cost to the consumer for the same or greater number of voice minutes, messages, and network data trends downward, resulting in decreased revenues (per user) over time recognized by the service provider.

Another issue is the means by which service providers charge consumers for the bandwidth used by their device applications. When device applications access the Internet through the mobile provider's gateway, the bandwidth usage is typically billed by counting the number of Kilobytes downloaded and then charging the consumer on a per-Kilobyte basis (usually aggregated into a monthly allowance in Megabytes). This is problematic for consumers for two reasons: one, many don't understand the technical concept of Kilobytes, and two, it is very difficult for the consumer to track the consumption of Kilobytes and relate that consumption to the limits described in their service agreement.

For fee-based services, the consumer is essentially billed twice—once for the service itself (such as a stock quote service), and then again for the Kilobytes transferred over the mobile provider's network. For “free” services, the consumer is still being billed for the Kilobytes transferred by the service which can be substantial, potentially resulting in expensive data plan overage charges. This double-billing for data services results from the lack of correlation between the utility of the mobile application to the consumer and the network bandwidth it utilizes.

It would be desirable to have a system which would facilitate the providers' ability to monetize their systems, as well as simplify the consumer experience by removing the notion of Kilobytes and the consumption of bandwidth as it relates to their service agreement. Such improvements are offered by the invention claimed herein.

### SUMMARY OF THE INVENTION

An important aspect of the invention is a method of monetizing a software application for mobile devices. The initial step is developing a software application designed to operate on a mobile device, which is followed by determining a transaction unit for the application. The program proceeds by estimating the bandwidth usage of the application, determining a pricing model for the application and deploying the application, based on the pricing model. Finally, the program performs the step of monitoring consumer usage of the application and adjusting the pricing model as required.

### BRIEF DESCRIPTION OF THE DRAWINGS

FIG. 1 illustrates the overall process of an embodiment of the invention.

FIG. 2 depicts in detail the portion of the process executing by the program developer.

FIG. 3 illustrates in detail the acceptance and testing procedures followed by the content provider after received the software.

FIG. 4 illustrates the deployment phase of the application, including evaluation and modification.

### DETAILED DESCRIPTION

The following detailed description is made with reference to the figures. Preferred embodiments are described to illustrate the present invention, not to limit its scope, which is defined solely by the claims. Those of ordinary skill in the art will recognize a variety of equivalent variations on the description that follows.

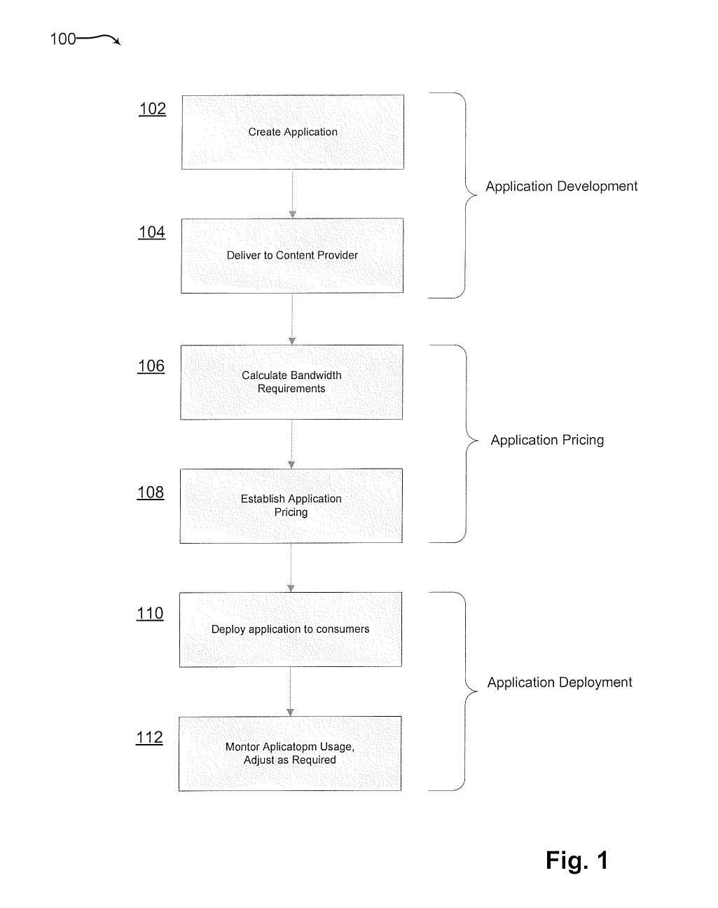

FIG. 1 depicts an embodiment 100 of the process of developing, deploying, and monitoring networked mobile applications as claimed herein. The term “networked mobile applications” relates generally to dynamically or statically installed content for mobile devices which access information via a computer network, such as mobile phones, Personal Digital Assistants (PDAs), or even automotive displays. The process is organized into three general phases, which can be summarized as Application Development, Application Pricing, and Application Deployment. The first phase begins at step 102, Create Application, where the application is developed, generally by an individual or company engaged in that task. Given the broad scope of encompassed by the term “content,” from ring tones to games to database applications, the universe of application developers can be highly diverse. After development, the application is delivered to a content provider (step 104), which as used herein indicates an entity that makes content available on a given mobile device, such as operators of mobile phone networks, such as Sprint, Cingular, T-Mobile, etc. Content providers may also be independent of actual mobile service providers, offering content through their own provisioning portals, or they could be aggregators which provide content transparently to a set of mobile service providers. In the second phase, the content provider receives the application from the application provider and then calculates the bandwidth required for the application (step 106) and establishes a price (step 108). The final phase describes the deployment of the application (step 110), followed by monitoring the application usage and making any required adjustments (step 112). Alternate embodiments may only include a subset or elements of the phases described here, as will be understood by those in the art.

It should be noted that the problems identified and solved in the present application are not encountered when dealing with users accessing the internet through a full computing device, such as a desktop or laptop computer, or even from a highly portable device such as a Pocket PC from Microsoft, or the like. Mobile devices require special attention most particularly because system providers bill based on usage, as noted above.

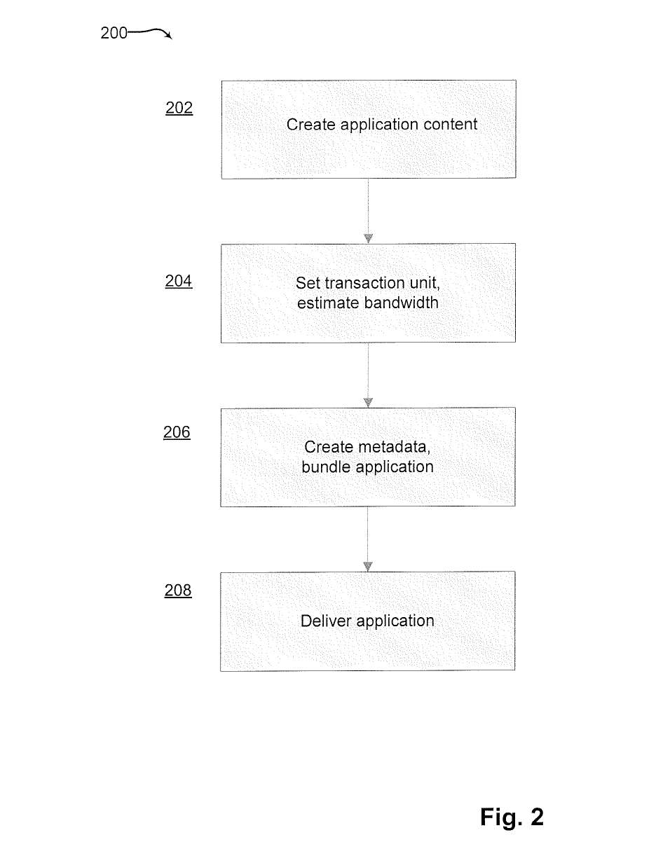

The detailed process begins with FIG. 2, which sets out the steps of networked mobile application development and submission. This process 200 generally describes the use and details of development tools customized for the purpose of the invention.

As a first step 202, the developer creates a networked application, adapted for deployment to a mobile handset. It is generally contemplated that such applications will be newly developed by the developer, but applications could also be adaptations, translations or modifications of previously-existing applications. The process of accomplishing such development is known to those in the art and will not be set out here in any further detail.

During development, the developer identifies a transaction period for the application, at step 204. The “transaction period” for an application is a measurable unit of operation, which is often closely associated with the intended billing model for the application. The notion of a transaction period is extremely flexible, and can range from one to several network queries to a measure of time. An important characteristic of transaction periods, and one that makes it impossible to generalize broadly about a process for matching a transaction period to an application, is that the nature of the transaction period mush fit the nature of the application, as can be seen in the examples set out below. The following list, while not exhaustive, demonstrates some typical application transaction periods: The most basic sort of period is a single network transaction, such as querying for and receiving driving directions from one point to another. Another is an identifiable group of network transactions, such as a multi-step product search, selection, and purchase process. Additionally, a measure of time can be used, such as usage for an hour, day, week, month, year, etc.

In an example of a single network transaction, an application may provide a graphical user interface which allows the user to input two different addresses: a source address and a destination address. When the user submits the data, the application begins the transaction period by opening a single network connection to a service which provides driving directions. The network connection may be implemented synchronously or asynchronously, depending on the attributes of the application environment or API used. For example, AJAX, the popular web browser API, provides for asynchronous network transactions, while the Java programming environment only provides for synchronous network transactions. Once the connection has been established, the input parameters provided by the user will be transmitted to the service and the service will respond with the directions from the source address to the destination address. After the response is received, the connection from the application to the service is closed and the transaction period concludes. The billing model for such a transaction is closely coupled in this case, where one can envision a charge for each network transaction. That is, the consumer may pay some fee, such as $1, each time he or she accesses directions from one address to another.

Alternatively, in some applications the most suitable transaction period may be an identifiable group of network transactions. For example, an application imay provide a graphical user interface which allows the user to search for movie theaters in his or her general location, then select a theater from that list and see a list of show times, and then select a movie from that list of show times and purchase tickets. The billing model for such a scenario would be a charge for purchasing the movie tickets, including the price of the tickets as well as a possible premium charge for purchasing the tickets using a mobile application. Superficially, this scenario looks similar to the typical surcharge today for buying movie tickets online via a web browser, but closer inspection reveals important differences. While the user views the “transaction” as purchasing movie tickets, in fact the system must accomplish a number of separate connections to achieve that result. Here, the ticket purchase includes one connection for querying for and receiving a list of theaters; one connection for querying for and receiving a list of show times, and one connection for selecting and purchasing a number of tickets for a particular show. Only by aggregating the network data transferred for the entire set of network transactions is it possible to compute the bandwidth required to accomplish the result of purchasing movie tickets. In some embodiments all three of the network connections may be performed using a single, continuously-maintained connection, such as HTTP's Keep-Alive support which maintains an open connection between the client and server and reuses that same physical connection for multiple request-response cycles.

Other applications make it possible to structure transactions covering a unit of time. For example, an application may provide the user with local weather forecast information, updated periodically. Here, it would be possible to base a billing model for such a scenario as a charge for receiving weather forecast information for a period of time, such as for an entire month, not for the individual receipt of a single weather update. Although this model entails a number of actual network transactions each day, it is possible to quantify the network bandwidth used for the entire month by measuring the requirements for a single weather update, and then multiplying by the number of such updates made during the entirety of the one month transaction period.

The developer specifies the transaction period through assistance from a development tool. This tool can employ known components such as wizards, which can lead the developer through a series of prompts in order to accurately determine, test, and specify the transaction period; transaction period templates; or conventional controls, such as pick lists and the like. As is familiar in the art, such components can be provided in the development tool's user interface.

In an example of a development tool's using a wizard process to establish the application's transaction period, the developer can be presented with a series of steps in a typical “wizard” visual interface. The wizard visual interface is one in which the user is presented with very simple questions which, when answered, lead the user to the next step in the process using controls such as “Next” to step forward and “Back” to step backward. The concept of a wizard should be well known to those skilled in the art. One of the first steps of the wizard may be to determine the application's billing model, in order to derive from that aspects of its transaction model. For example, the first step may be to select from a list of billing choices, such as Pay-per-use, or Subscription. If the developer chooses Pay-per-use, then the tools know the transaction period consists of either a single or a set of network transactions. If the developer chooses Subscription, then the transaction period consists of all network transactions occurring over a timed interval. If the developer chose Pay-per-use, the next panel in the wizard may ask the developer to select whether the transaction period consists of a single network transaction (such as the case described previously of querying for driving directions), or a set of network transactions (such as the case described previously of purchasing movie tickets). Should the user select a single network transaction, the wizard may conclude by providing a means for the developer to identify that connection in the code (such as a search or browse feature). Should the user select the multiple connections option, the wizard may conclude with a process which identifies the set of those connections (such as the record process described below). Were the developer to select Subscription, rather than Pay-per-use in the first step, the wizard may have continued on to query the developer for the timeframe of the subscription, as well as identify the network connection and the frequency at which it is utilized. Regardless of the developer's path through the wizard, the process concludes with identification having been made of the application's billing model, its transaction period, its network connections, and the frequency of their usage.

This and other components are available for inclusion in a development tool, and their use is understood by those in the art. Any of these can be employed to construct a suitable interface, once the principles set out above have been employed to select a transaction unit.

Once the transaction unit has been identified, the development tools can monitor and report bandwidth usage during the transaction period. For time-based transaction periods (subscriptions), the tools may assist the developer in calculating the bandwidth usage for its entirety, even when it would be impractical to do so manually.

Generally, the development tools integrate an application runtime which includes additional execution instrumentation. This additional instrumentation enables the development tools to provide rich debugging features for the developer, such as the detailed bandwidth usage from the networking implementation. For example, the network instrumentation monitors and collects information concerning all network connections made by a running application. That information is then exposed via proprietary APIs to the developer tools, including the network destination, the connection status of the network, the data transferred to the remote destination, the data received from the remote destination, the speed at which the data was sent and received, and any other interesting network details or statistics. Using this detailed data from the application runtime, the development tools can present usable views and insights to the developer, such as network efficiency, latency, number of bytes sent, number of bytes received, number of network connections made, etc. It is this mechanism which enables the development tools to provide the detailed bandwidth usage information for the variety of application transaction periods.

For example, when specifying an application transaction period of a single network transaction, the development tools can utilize the runtime instrumentation to monitor, measure, and report on the number of kilobytes transferred during that transaction. This is done simply by the runtime by counting the number of bytes sent and received on the network socket for the application's network transaction.

When specifying an application transaction period comprised of a group of network transactions, the development tools can again utilize the runtime instrumentation to monitor, measure, and report on the total number of kilobytes transferred during each network transaction. The tools can then present aggregate statistics by combining the data across the span of network transactions from the first request to the last. For some statistics, this may simply be a summation, such as total kilobytes sent or received. For other statistics, this may involve calculating statistical values such as medians and averages for the set of network connections that comprise the transaction period.

Using the bandwidth usage calculated from the application's network transaction(s) (BW) combined with the usage frequency of the application (F per U, where U is a unit of time) and the length of the subscription period (T), the application's bandwidth usage during the subscription period can be estimated with the formula:

BW*F*(T/U)=[total bandwidth used during the subscription period]

For example, if an application with a monthly subscription utilizes 5 kilobytes of network data for one ore more network connections, and in the course of one day performs that operation approximately 10 times, then the total estimated bandwidth usage for that application during the course of its monthly subscription (based on a 30 day month) would be:

5*10*(30 days/1 day)=1500 kilobytes

The only important consideration is that the unit of measure for the subscription length (T) and the unit of time in which the usage frequency is specified (U) are the same. For example, if that same application had a usage frequency of 10 times an hour, then the total estimated bandwidth usage for the month long subscription would be:

5*10*(720 hours/1 hour)=36000 kilobytes

Or stated differently, a frequency of 10 times an hour would be equivalent to 240 times a day, or:

5*240*(30 days/1 day)=36000 kilobytes

An example where the (T/U) ratio is important would be if the usage frequency was something like 10 times in 6 hours, represented by:

5*10*(720 hours/6 hours)=6000 kilobytes

Using this algorithm and the methods mentioned previously for measuring bandwidth, an application with a time-based transaction period can have its bandwidth usage estimated and projected for the duration of the subscription period without actually running the application for the entire subscription period. This is quite useful for the typical monthly subscription period where no one would wish to wait an actual month to determine the bandwidth consumption. It should be noted that the frequency of use for the application may be a “best guess” or projected average during the application's development stage. Once the application is deployed, real consumer usage statistics can be utilized to ensure that any guess or average is correct, or provide a more accurate value in the case it is not.

After identifying the bandwidth usage for the transaction period, a cost can be assigned to the bandwidth. This can be accomplished in several ways, such as the following examples. In one embodiment, the development tools may connect to a remote server and retrieve the current cost of bandwidth (per kilobyte) as a median, average, or for a specific content provider. Another embodiment can provide that the developer may directly specify a cost (per kilobyte), such as through a dialog, preference, wizard or property sheet. In yet another embodiment, development tools may identify the developer to a remote server and load a unique pricing arrangement for the developer.

Given the cost per kilobyte, the development tools can report the cumulative cost of the bandwidth usage during the application's transaction period by multiplying the number of kilobytes transferred during the transaction period by the cost per kilobyte. If the developer has any special pricing arrangement, those considerations are also applied to arrive at the final cost of bandwidth for the application.

Knowing the amount and cost of the bandwidth at development time enables the developer to make optimization decisions before deploying the application to content providers. In this manner, the tools enable the developer to perform an iterative process of optimization, bandwidth usage calculation, and cost analysis. Once the developer is satisfied with the bandwidth usage, the application is ready to be bundled and delivered.

The developer may optionally at this point deliver the application to an “application provider”. The term “application provider” refers to the entity which maintains a relationship with the content provider and delivers them the application. The application developer may act as the application provider directly, or the two may be separate entities. An example of the latter would be when an application provider contracts with an application developer to create a given application.

Prior to delivery to the content provider, the application provider will complete any final meta-data about the application, as shown in step 206. Such meta-data includes information such as title, version, author, creation date, platform version, etc. The entry of this meta-data may be facilitated by the development tools through an interactive wizard, integrated property sheet, or some other means. The meta-data may be stored using some common industry method, such as a properties file, an XML file, or some other scheme. This scheme will be part of the relationship defined by the content provider. For example, as part of the contract for delivery, the content provider may require an XML document with a predetermined name to be included in the application bundle (often compressed via ZIP or JAR). Once the application bundle is submitted to the content provider the XML document with the predetermined name (for example, “properties.xml”) can be programmatically accessed, parsed, and read. The format of the XML file may be defined by a DTD (Document Type Definition) specified by the content provider or it may instead be a free-form document.

The application provider may also set the application's list price. It becomes clear at this point why the bandwidth cost is an important factor in the process. In cases where the content provider directs the bandwidth cost of the application back to the application provider, the application provider must set the list price such that bandwidth costs can be covered and provide the desired profit margin. Applications which are provided for free to consumers may be accounted for by a special arrangement between the application provider and the content provider, paid for by sponsors or advertisers, or through some other means.

As a final action before shipment, the development tools are used to create an application bundle suitable for delivery to the content provider. The application bundle would include the application, its resources, and its meta-data described above. The application bundle may optionally be compressed prior to submission using a typical compression scheme such as ZIP, RAR, JAR, etc. The final application bundle is then submitted to the content provider, step 208, for approval and deployment on the content provider's network. This may be done electronically by the development tools, as part of an Internet portal via a web browser, uploaded via File Transfer Protocol (FTP) or Secure Shell (SSH), or by some other means of transfer agreed upon by the application provider and content provider.

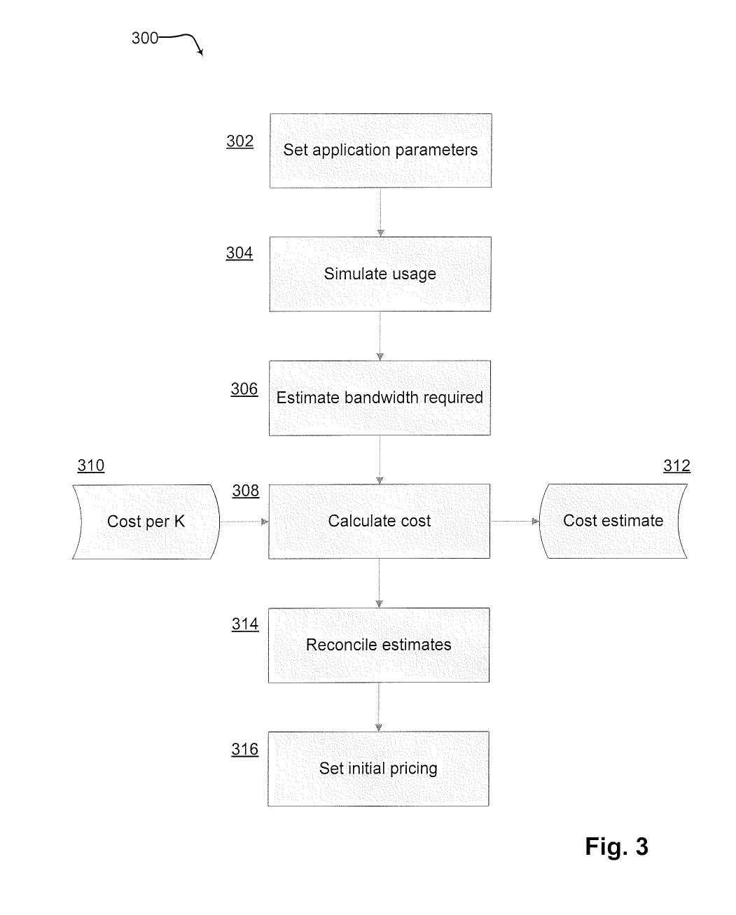

FIG. 3 details the application processing and pricing process 300 by the content provider. The steps performed by the content provider after receiving the application bundle are to determine the application's transaction period, estimate its bandwidth usage, determine its price, billing model, and validate any other necessary meta-data, steps subsumed under the label “setting parameters”, step 302. In the embodiment described here, such meta-data is provided in or along with the application bundle by the application provider and can be programmatically processed. Other embodiments may not provide such a convenient processing path, requiring that such functions be performed by the application provider, requiring the content provider to derive such information where possible. Such a case may exist for legacy content developed prior to the utilization of the bandwidth assessment process described herein.

Similarly to the steps described previously, the content provider also has tools to validate the submitted application and prepare it for deployment. The implementation and functionality of both toolsets are very similar, with the difference that one set is designed for use by a developer or application provider, and the other is designed for use by a content provider. Thus the two toolsets share much of their functionality (such as the application simulator, bandwidth monitoring, etc.) but each has a user interface and options which are specific to the target user.

The content provider can begin by loading the application bundle into the development tool, where the application's meta-data file can be processed. The application parameters can first be validated programmatically by the tools (such as ensuring a time value occurs within logical constraints, ensuring a version string is present, etc.) and then can be presented to the content provider via the user interface for any final human validation. This final human validation may be necessary if certain values are valid numerically but are nonsensical in some cases when reviewed by human logic.

The content provider can then continue by executing the application in a simulator, step 304. The simulator provides a runtime environment similar to that of the devices targeted for deployment, and similar to that provided by the developer tools. This simulator enables the content provider to execute and observe the application without requiring the application to be loaded on an actual device. The content provider can then validate the usability of the application, its language, graphics, functionality, etc. The simulator is also capable of monitoring and reporting the application's network bandwidth usage in the same manner in which was described previously for the development tools.

The content provider will continue to interact with the application to verify the transaction period defined by the application provider is acceptable. For example, using the previous example of a weather application, if the application provider had specified a pay-per-use transaction period (meaning the consumer would be charged each time the weather information is retrieved from the network), the content provider could flag this as being an inappropriate model and substitute a more suitable pricing plan. Since the weather application retrieves network data at regular intervals each day, its transaction period should be time-based, such as a monthly subscription as discussed previously. It may not be possible for the tools to automatically detect and report such an inconsistency, which is why the content provider may use the simulator to run the application and verify the application's transaction period. If the transaction period is found to be incorrect, the application deployment process may not continue and the application provider may be notified and asked to review and possibly correct the inconsistency.

After verifying that the application's transaction period is correct, it is possible to estimate bandwidth requirements, step 306. The simulator monitors and reports bandwidth as described previously for the developer tools. The tools monitor the application's network connections and maintain totals of the number of kilobytes transferred. This may be for a single network connection, a set of network connections, as well as for a period of time which is used to extrapolate time-based transaction period usage, as described previously.

Once the application's bandwidth usage is measured, a cost can be assigned to the bandwidth, in step 308, similar as to what was described during the application development process. The total cost of the application's bandwidth usage can be described using the formula:

C=K*P

where C is the total cost of bandwidth, K is the number of kilobytes used, and P is the price of that bandwidth per kilobyte. The content provider has already used the simulator and tools to verify the transaction period and measure the applications bandwidth in kilobytes (K). All that remains is to enter a price (P) and the tools will perform the cost calculation and report it to the content provider via the visual interface. The price (P) can be specified in several ways, including loading the value from a server or database or via a preference or property setting in the content provider's toolset.

For example, the cost per kilobyte may be stored in a separately maintained database by the content provider, as shown in step 310. This enables the content provider to have the flexibility in maintaining different cost structures for different application types or providers. An application provider may provide a multitude of applications to the content provider and in exchange may possibly have negotiated a better bulk pricing rate for the bandwidth used by those applications as compared to application providers whom only develop a small number of applications. Keeping these details in a database enables the tools to utilize the application bundle's meta-data file to identify the application provider, look up the specific pricing structure for that application provider in the content provider's pricing database, and then programmatically perform the cost function and report the application's bandwidth cost to the content provider.

If the content provider does not offer such flexible pricing schemes, the process can be simplified by setting a single cost per kilobyte in the content provider's toolset. This could be done by choosing a ‘Preferences’ option from the ‘Edit’ menu in the toolset which opens an application preferences dialog and provides a visual interface for the content provider to set a bandwidth cost. If such a setting has not been previously input by the content provider, the tools may instead prompt the content provider with a dialog to enter a value. Once the bandwidth cost is known to the tools, the tools will programmatically perform the cost function and report the application's bandwidth cost to the content provider, step 312.

At this point the content provider may compare the cost values obtained in the simulator with any values provided with the application from the application provider, in step 314, if such values were included. If there is a disparity in the comparison, the content provider has an option to resolve such discrepancies with the application provider, prior to proceeding any further with deploying the application. Such resolution may involve the automatic application of policy, such as utilizing the higher of the two values or some other applicable policy or communication with the application provider.

After any discrepancies are resolved, the content provider can proceed to establish a price for the application, step 316, using the application's bandwidth cost, the desired list price established by the application provider, and any other factors or considerations of the content provider's revenue distribution model. After all necessary information for the application has been established for deployment, a new entry encapsulating that information can be created in the content provider's content catalog. The application is then ready to be deployed by the content provider and made available to consumers. The application packaging details may be specific to the content provider's content provisioning server and are beyond the scope of this invention.

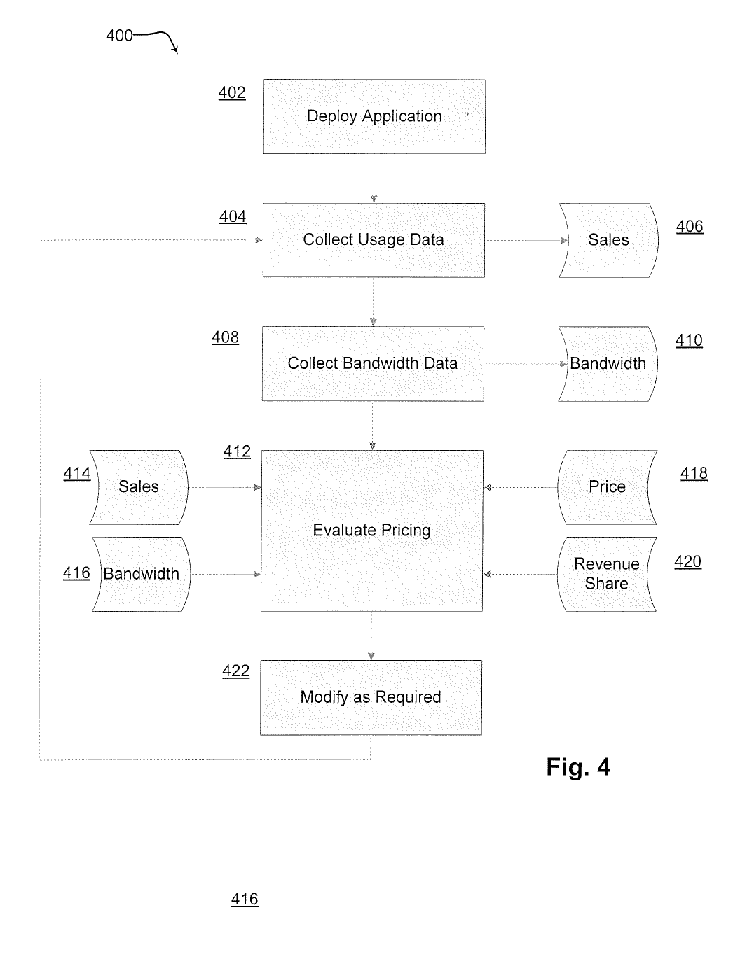

FIG. 4 details the application deployment and price adjustment process 400 by the content provider. The first step is for the content provider to deploy the application bundle, step 402, by making it available for download by consumers. This may involve various mechanisms, such as adding the application to a provisioning server, notifications to users, placement on the content provider's WAP deck, promotions, etc., all as known in the art.

Once deployed, the content provider will collect and store usage data about the application, steps 404 and 408. Such usage data may include bandwidth usage, frequency of use, specific feature use, trial conversion, etc., and store the information in appropriate databases, 406 and 410. Specialized software on the device will record this information and periodically connect to the content provider's server and report it. By collecting this information from the actual consumer devices after the application has been deployed, a comparison can be made to the projections made prior to the deployment of the application. This may be done consistently for all devices which run the application, or possibly only a suitable sample, sized adequately in order to draw statistically meaningful conclusions for the rest of the population.

For example, each device may actively record statistical information and report that to the content provider's centralized server. However, depending on the number of those devices, it may not be sensible or useful for the content provider to store every device's information. It is well known in the discipline of statistics and numerical analysis that meaningful conclusions for a population can be made based on the study of a certain subset (or sample size) of that population. The content provider may certainly store all of the information from every device, allowing the greatest possible breadth and depth of analysis possible. However, the content provider may also store the information from a certain sample size of devices based on some selection criteria. The size of the sample is determined by sizing the overall population. The content provider may wish to simply choose a randomly distributed subset from the overall population, or for potentially better results, may define sub-groups of the overall population and choose a randomly distributed subset from each of those sub groups.

For example, a content provider may have an overall population of 1 million devices. It could be that a statistically valuable sample size of that population is 10,000 devices, so the content provider may select an even, randomly distributed subset of size 10,000 from the overall population. This selected subset of devices will then have its statistical information reported to and stored in the content provider's database for later data analysis. This subset should then have the same characteristic distribution as the population, such as 51% female, 23% gamers, 10% seniors, etc., in order to draw statistically meaningful results from the population as based on the sample. However, it could be that the size of a particular demographic within the subset is too small to be accurate, or potentially even left out entirely if the demographic is extremely targeted and the content provider has few of those customers. In this case, the content provider may instead decide to store all of the device information from that particular demographic, such as all devices in the overall population who have installed a particular type of game. Alternatively, the content provider may choose an individual sample of that demographic, but sized appropriately using the size of the target demographic, not of the overall population.

That is, if the number of all teenagers who have played “Game X” is 10,000, the sample size representative of that population may be 1,000. However, if the total number was only 1,000, the content provider may wish to record and analyze the usage statistics of all 1,000 members of that demographic.

In this manner, the content provider can utilize both analysis methods to determine the most efficient amount of data to store in its database in order to perform the most accurate data analysis possible on any particular demographic or overall population.

After collecting and storing information about the application and its deployment, the content provider can review and optionally update the application's market price, at steps 412 and 422, taking as inputs the sales data 414, bandwidth data 416, price data 418 and revenue sharing data, 420. For example, if the estimated bandwidth usage calculated prior to the application's deployment is found to be substantially different than the bandwidth usage of the application as measured after deployment, the application's price may need to be adjusted either upward to accommodate higher-than-expected bandwidth usage or downward to reflect a discount for lower-than-expected usage. This ensures the content provider is adequately compensated for bandwidth usage over time without charging the consumer on a per-kilobyte basis. This bandwidth usage price update process may optionally include the involvement of the application provider, in order to account for their potential interest in the revenue distribution model. The post-deployment bandwidth information may also be used to improve the developer tools, the application simulation tools, and the pre-deployment bandwidth estimation process, as well as any other applicable steps of the process. The content provider may also adjust its bandwidth pricing over time and thus reflect those pricing adjustments by updating the market price of the application.

The content provider may also adjust the application's price at this point utilizing the application's sales statistics information. This review process may involve using some or all of the data recorded concerning the application's sales statistics, promotional conversions, bandwidth consumption, etc. Once again, there may be some involvement by the application provider in this process, in order to arrive at a price for the application which is acceptable by both parties.

The description of the invention herein generally asserts that the consumer is being charged for the application; however, this may not always be the case. Some applications may in fact be free to the consumer. In those cases, the content provider may redirect the cost of the application's bandwidth to some sort of sponsor or even to themselves. For example, an entity such as a TV gameshow could produce an application allowing consumers to vote for their favorite contestants. Such an application may in fact be free to the consumer; however the concepts described herein such as the application's transaction period and bandwidth usage still apply. The content provider may then redirect the cost of the application to another party, such as the TV gameshow in this example or some other sponsor or entity. The content provider may also decide to not charge any entity for the application.

Regardless of who actually pays for the application, the invention described herein enables the content provider to direct the cost of the bandwidth for the application to the appropriate party. This may be the application provider, the application sponsor, some other entity, or even the content provider themselves. This process can then be used to free the consumer from being charged for bandwidth usage, place appropriate incentive on application developers to use network resources efficiently, and enable the content provider to monetize the use of their networks according to the utility and services they provide.

The general process is now concluded. However, the information collection and application price adjustment described in FIG. 4 may continue as a repetitive process throughout the lifespan of the application.

We claim as follows:

1. A method of monetizing a software application for mobile devices, including the steps of:
developing a software application designed to operate on a mobile device;
determining a transaction unit for the application;
estimating the bandwidth usage of the application;
determining a pricing model for the application;
deploying the application, based on the pricing model;
monitoring consumer usage of the application;
adjusting the pricing model as required.

2. The method of claim 1, wherein the transaction unit is based on a single communication transaction.

3. The method of claim 1, wherein the transaction unit is based on a series of communication transactions.

4. The method of claim 1, wherein transaction unit is based on an unlimited number communication transactions occurring during a set unit of time.

5. The method of claim 1, further including the step of assembling metadata and bundling the metadata together with the application for delivery.

6. The method of claim 1, wherein the application is developed by an application developer and subsequently delivered to a content provider for testing and deployment.

7. A system for planning the pricing for a mobile application, comprising:
an input module, programmed to accept user inputs setting out transaction units, transaction periods and bandwidth usage;
a bandwidth estimation module, programmed to calculate estimates of bandwidth usage, based on the user inputs; and
a cost estimation module, programmed to calculate total costs over a transaction period, based on the user inputs.

8. The system of claim 7, wherein the transaction unit is based on a single communication transaction.

9. The system of claim 7, wherein the transaction unit is based on a series of communication transactions.

10. The system of claim 7, wherein transaction unit is based on an unlimited number communication transactions occurring during a set unit of time.

11. A system for testing the pricing for a mobile application, comprising:
a test setup module, programmed to accept a software program for test and evaluation and to establish program parameters, based on metadata provided with the program under test;
a simulation module, programmed to simulate an operating environment for the program under test, including a submodule for establishing values for operating and environmental variables;
a bandwidth estimation module, programmed to calculate bandwidth requirements for the program under test;
a calculation module, for calculating cost estimates based on the results of the simulation module;
a reconciliation module, programmed to compare evaluation results achieved by the simulation module with data provided in the program metadata, to identify and alleviate discrepancies; and
a price recommendation module for integrating the results of the simulation and calculation modules.

12. The system of claim 11, wherein the transaction unit is based on a single communication transaction.

13. The system of claim 11, wherein the transaction unit is based on a series of communication transactions.

14. The system of claim 11, wherein transaction unit is based on an unlimited number communication transactions occurring during a set unit of time.

15. The system of claim 11, further including the steps of collecting and storing data regarding actual time and bandwidth usage of the program.

16. The system of claim 15, further including the steps of evaluating the price recommendation against collected usage and bandwidth information and recommending modifications to the initial recommendation.

17. The system of claim 11, wherein transaction unit is based on an unlimited number communication transactions occurring during a set unit of time.
